(19) United States
(12) Patent Application Publication
(10) Pub. No.: US 2008/0036593 A1
(43) Pub. Date: Feb. 14, 2008

(54) VOLUME SENSOR: DATA FUSION-BASED, MULTI-SENSOR SYSTEM FOR ADVANCED DAMAGE CONTROL

(75) Inventors: Susan L. Rose-Pehrsson, Fairfax, VA (US); Frederick Williams, Accokeek, MD (US); Jeffrey C. Owrutsky, Silver Spring, MD (US); Daniel T. Gottuk, Ellicott City, MD (US); Daniel A. Steinhurst, Alexandria, VA (US); Christian P. Minor, Potomac, MD (US); Stephen C. Wales, Great Falls, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the US, as represented by the Secretary of the Navy, Washington, DC (US)

(21) Appl. No.: 11/833,753

(22) Filed: Aug. 3, 2007

Related U.S. Application Data
(60) Provisional application No. 60/821,476, filed on Aug. 4, 2006.

(51) Int. Cl. G08B 21/00

(52) U.S. Cl. 340/540

(57) ABSTRACT

Provided a system and method for detecting an event while discriminating against false alarms in a monitored space using at least one sensor suite to acquire signals, transmitting the signals to a sensor system device where the signal is processed into data packets, transmitting the data packets to a data fusion device, where the data packets are aggregated and algorithmic data fusion analysis is performed to generate threat level information. The threat level information is distributed to a supervisory control system where an alarm level can be generated when predetermined criteria are met to indicate the occurrence of an event in the monitored space.

### CROSS-REFERENCE TO RELATED APPLICATIONS

This application is a Non-Prov of Prov (35 USC 119(e)) application 60/821,476 filed on Aug. 4, 2006.

### BACKGROUND OF THE INVENTION

Fire detection systems and methods are employed in most commercial and industrial environments, as well as in shipboard environments that include commercial and naval maritime vessels. Conventional systems typically have disadvantages that include high false alarm rates, poor response times, and overall sensitivity problems. Although it is desirable to have a system that promptly and accurately responds to a fire occurrence, it as also necessary to provide one that is not activated by spurious events, especially if the space contains high-valued, sensitive materials or the release of a fire suppressant is involved.

Humans have traditionally been the fire detectors used on most Navy ships. They are multi-sensory detection systems combining the sense of smell, sight, hearing, and touch with a very sophisticated neural network (the brain). The need for reduced manning on ships requires technology to replace some of the functions currently achieved by sailors. Standard spot-type smoke detectors are commercially available. However, smoke detectors are actually particle detectors, with ionization and photoelectric smoke detectors detecting different size particles. Therefore, ionization devices have a high sensitivity to flaming fires, while photoelectric detectors are more sensitive to smoldering fires. For the best protection, a multicriteria or multi-sensory approach is required. Multicriteria fire detectors are commercially available. These detectors are point detectors and require the smoke to diffuse to the sensors. The detection results depend on the types of fire tested, the location of the fire and the available ventilation levels within the compartment. For smoldering fires, the smoke moves slowly to the overhead where the detectors are located and the detector responses can be delayed for greater than 30 minutes (and possibly never alarm if the smoke is heavily stratified).

Economical fire and smoke detectors are used in residential and commercial security, with a principal goal of high sensitivity and accuracy. The sensors are typically point detectors, such as photoionization, photoelectron, and heat sensors. Line detectors such as beam smoke detectors also have been deployed in warehouse-type compartments. These sensors rely on diffusion, the transport of smoke, heat or gases to operate. Some recently proposed systems incorporate different types of point detectors into a neural network, which may achieve better accuracy and response times than individual single sensors alone but lack the faster response time possible with remote sensing. e.g., optical detection. Remote sensing methods do not rely on effluent diffusion to operate.

An optical fire detector (OFD) can monitor a space remotely i.e. without having to rely on diffusion, and in principle can respond faster than point detectors. A drawback is that it is most effective with a direct line of sight (LOS) to the source, therefore a single detector may not provide effective coverage for a monitored space. Commercial OFDs typically employ a single/multiple detection approach, sensing emitted radiation in narrow spectral regions where flames emit strongly. Most OFDs include mid infrared (MIR) detection, particularly at 4.3 μm, where there is strong emission from carbon dioxide. OFDs are effective at monitoring a wide area, but these are primarily flame detectors and not very sensitive to smoldering fires. These are also not effective for detecting hot objects or reflected light. This is due to the sensitivity trade-offs necessary to keep the false alarm rates for the OFDs low. Other approaches such as thermal imaging using a mid infrared camera are generally too expensive for most applications.

Video Image Detection Systems (VIDS) use video cameras operating in the visible range and analyze the images using machine vision. These are most effective at identifying smoke and less successful at detecting flame, particularly for small, emergent source (either directly or indirectly viewed, or hot objects). Hybrid or combined systems incorporating VIDS have been developed in which additional functionality is achieved using radiation emission sensor-based systems for improved response times, better false alarm resistance, and better coverage of the area with a minimum number of sensors, especially for obstructed or cluttered spaces. The video-based detection systems using smoke and fire alarm algorithms can provide comparable to better fire detection than point-type smoke detectors. The main exception is that the video-based systems do not respond to small flaming fires as well as ionization smoke detectors. The video-based systems generally outperformed both ionization and photoelectric smoke detectors in detecting smoldering fires. The video-based systems demonstrate comparable nuisance alarm immunity to the point-type smoke detection systems with similar alarms, except the VID systems sometimes false alarmed to people moving in the space.

U.S. Pat. No. 5,937,077, Chan et al., describes an imaging flame detection system that uses a charge coupled device (CCD) array sensitive in the IR range to detect IR images indicative of a fire. A narrow band IR filter centered at 1,140 nm is provided to remove false alarms resulting from the background image. Its disadvantages include that it does not sense in the visible or near-IR region, and it does not disclose the capability to detect reflected or indirect radiation from a fire, limiting its effectiveness, especially regarding the goal of maximum area coverage for spaces that are cluttered in which many areas cannot be monitored via line of sight detection using a single sensor unit.

U.S. Pat. No. 6,111,511, Sivathanu et al. describes photodiode detector reflected radiation detection capability but does not describe an image detection capability. The lack of an imaging capability limits its usefulness in discriminating between real fires and false alarms and in identifying the nature of the source emission, which is presumably hot. This approach is more suitable for background-free environments. e.g., for monitoring forest fires, tunnels, or aircraft cargo bays, but is not as robust for indoor environments or those with a significant background variation difficult to discriminate against.

U.S. Pat. No. 6,529,132, G. Boucourt, discloses a device for monitoring an enclosure, such as an aircraft hold, that includes a CCD sensor-based camera, sensitive in the range of 0.4 μm to 1.1 μm, fitted with an infrared filter filtering between 0.4 μm and 0.8 μm. The device is positioned to detect the shifting of contents in the hold as well as to detect direct radiation. It does not disclose a method of optimally positioning the device to detect obstructed views of fires by sensing indirect fire radiation or suggest a manner in which the device would be installed in a ship space. The disclosed motion detection method is limited to image scenes with little or no dynamic motion.

U.S. Pat. No. 7,154,400, Owrutsky, et al., incorporated herein in full by reference, discloses a method for detecting a fire while discriminating against false alarms in a monitored space containing obstructed and partially obstructed views. Indirect radiation, such as radiation scattered and reflected from common building or shipboard materials and components, indicative of a fire can be detected. The system, used in combination with Video Image Detection Systems (VIDS), can theoretically detect both fire and smoke for an entire compartment without either kind of source having to be in the direct LOS of the cameras, so that the entire space can be monitored for both kinds of sources with a single system.

Multisensor, multicriteria sensing systems address the need for automated monitoring and assessment of events of interest within a space, such as chemical agent dispersal, toxic chemical spills, and fire or flood detection. A multisensor, multicriteria sensing system offers benefits over more conventional point detection systems in terms of robustness, sensitivity, selectivity, and applicability. Multimodal, spatially dispersed and network-enabled sensing platforms can generate complementary datasets that can be both mined with pattern recognition and feature selection techniques and merged with event-specific data fusion algorithms to effectively increase the signal to noise ratio of the system (an effect analogous to signal averaging) while also offering the potential for detecting a wider range of analytes or events. Additionally, such systems offer potential for resilience to missing data and spurious sensor readings and malfunctions that is not possible with individual sensing units. In this way, multimodal systems can provide faster and more accurate situational awareness than can be obtained with conventional sensor implementations. Finally, a spatially, or even geographically, dispersed array of networked sensors can provide the necessary platform flexibility to accommodate diverse configurations of fixed or mobile, standoff or point sensors to satisfy a wide range of monitoring and assessment needs.

Multisensor and multicriteria approaches to fire detection have demonstrated improved detection performance when compared to standard spot-type fire sensors and have rapidly become the industry state-of-the-art. Multisensor systems generally rely on some form of smart data fusion to achieve higher rates of detection and lower numbers of false alarms. Significant improvements in the accuracy, sensitivity and response times in fire and smoke detection using multicriteria approaches that utilize probabilistic neural network algorithms to combine data from various fire sensors has been demonstrated. Using a multisensor, multicriteria approach with data fusion for the detection of chemical agents and unexploded ordinance has been previously demonstrated.

Likewise, multisensor detection systems have shown a number of advantages over comparable single sensor systems for the detection of chemical weapons agents and toxic industrial chemicals (CWA/TIC), as evidenced by a number of successful and commercially available multisensor-based detection systems for CWA/TIC applications. Examples systems are the Gas Detector Array II (GDA-2) by Airsense Analytics and the HAZMATCAD Plus by Microsensor Systems, Inc. Both of these systems are portable devices capable of point-detection of a wide variety of chemical agents and toxic compounds. The GDA-2 uses ion mobility spectrometry supplemented with photoionization detection, electrochemical, and metal-oxide sensors. The HAZMATCAD Plus uses surface acoustic waves sensors supplemented with electrochemical sensors. In addition, “multi-way” analytical instrumentation, such as hyperspectral imaging technology, can be considered a multicriteria approach applied to standoff detection of CWA/TIC in that such instruments utilize additional axes of measurement to provide the same types of advantages conferred by multiple sensors. The Adaptive InfraRed Imaging Spectrometer (AIRIS) by Physical Sciences. Inc. is an example of one such hyperspectral imaging system targeted for CWA/TIC detection applications.

Advances in communications and sensor technologies in recent years have made possible sophisticated implementations of heterogeneous sensor platforms for situational awareness. However, such networked multisensor systems present their own unique set of development and implementation challenges. Care must be taken in selecting sensing modalities and sensors that provide complementary information appropriate to the sensing application being developed. A suitable network architecture and communications interface must be designed that is amenable to the differing data formats and interfaces typical of commercially developed sensors. To realize the benefits of a multimodal approach, sensor data must be combined and evaluated in a manner that enhances performance without increasing false positives. These challenges are in addition to those common to conventional sensor implementations: developing pattern recognition and feature extraction algorithms tailored to multiple event recognition and implementing a real-time data acquisition and analysis and command and control framework for the sensing system.

### BRIEF SUMMARY OF THE INVENTION

Disclosed is a method for detecting an event while discriminating against false alarms in a monitored space using at least one sensor suite to acquire signals, transmitting the signals to a sensor system device where the signal is processed into data packets, transmitting the data packets to a data fusion device, where the data packets are aggregated and algorithmic data fusion analysis is performed to generate threat level information. The threat level information is distributed to a supervisory control system where an alarm level can be generated when predetermined criteria are met to indicate the occurrence of an event in the monitored space.

### BRIEF DESCRIPTION OF THE DRAWINGS

FIG. 1 is a Volume Sensor system architecture and components;

FIG. 2 is a proof-of-concept sensor suite showing the various sensing elements;

FIG. 3 is a diagram of operations office with sensor suites 5 (SS5) and 6 (SS6);

FIG. 4 is a view from sensor suite 5, operations office, (b) View from sensor suite 6, operations office;

FIG. 5 shows the percentage of 32 flaming sources detected within the specified intervals;

FIG. 6 shows the percentage of 26 smoldering sources detected within the specified interval;

FIG. 7 shows the correct classification of fire sources and rates of false positives from nuisance sources.

### DETAILED DESCRIPTION OF THE INVENTION

An affordable, automated, real-time detection system has been developed to address the need for detection capabilities for standoff identification of events within a space, such as fire, explosions, pipe ruptures, and flooding level. The system employs smart data fusion to integrate a diverse group of sensing modalities and network components for autonomic damage control monitoring and real-time situational awareness, particularly on U.S. Navy ships. This Volume Sensor system comprises spectral and acoustic sensors, new video imaging techniques, and image recognition methods. A multi-sensory data fusion approach is used to combine these sensor and algorithm outputs to improve event detection rates while reducing false positives, providing a system with detection capabilities for standoff identification of events within a space, such as fire, explosions, pipe ruptures, and flooding level. The Volume Sensor system required the development of an efficient, scalable, and adaptable design framework. A number of challenges addressed during the development were met with solutions that are applicable to heterogeneous sensor networks of any type. Thus, Volume Sensor can serve as a template for heterogeneous sensor integration for situational awareness. These solutions include: 1) a uniform but general format for encapsulating sensor data, 2) a communications protocol for the transfer of sensor data and command and control of networked sensor systems, 3) the development of event-specific data fusion algorithms, and 4) the design and implementation of a modular and scalable system architecture.

In full-scale testing on a shipboard environment, two prototype Volume Sensor systems demonstrated the capability to provide highly accurate and timely situational awareness regarding damage control events while simultaneously imparting a negligible footprint on the ship's 100 Mbps Ethernet network and maintaining smooth and reliable operation. The prototype systems were shown to outperform the standoff and spot-type commercial fire detection systems for flaming and smoldering fires with a high immunity to nuisance sources. In addition, the prototypes accurately identified pipe ruptures, flooding events, and gas releases.

The Volume Sensor approach was to build a multisensor, multicriteria system from low cost commercial-off-the-shelf (COTS) hardware components integrated with intelligent software and smart data fusion algorithms for the Volume Sensor. This effort took advantage of existing and emerging technology in the fields of optics, acoustics, image analysis and computer processing to add functionality to conventional surveillance camera installations planned for in new ship designs. A diverse group of sensing modalities and network components was chosen using criteria that emphasized not only their capability to provide pertinent damage control information, but also their cost and ability to be integrated into existing ship infrastructure. Various spectral and acoustic sensors, new video imaging techniques, and image recognition methods were investigated and evaluated. The selected sensing platforms were integrated into “sensor suites” that incorporated video cameras, long wavelength (near infrared) filtered cameras, single element spectral sensors, and human-audible microphones. A multisensory data fusion approach was used to provide overall detection capabilities for standoff identification of damage control events within shipboard spaces. Data fusion decision algorithms were used to improve event detection rates while reducing false positives and, most importantly, intelligently combine all available sensor data and information to provide the best possible situational awareness.

The Volume Sensor employs intelligent machine vision algorithms to analyze video images from cameras mounted in shipboard spaces for the detection of damage control events like fires. Video-based fire detection systems built around typical surveillance cameras are a recent technological advancement. See Privalov et al. U.S. Pat. No. 6,184,792 and Rizzotti et al. U.S. Pat. No. 6,937,742. Video image detection (VID) systems operate by analyzing video images produced by standard surveillance cameras (typically up to eight per unit) in order to detect smoke or fire in large spaces such as warehouses and transportation tunnels. Recent versions of these VID systems include detection algorithms that differentiate between flaming and smoldering fires. The systems differ mostly in the image analysis algorithms they employ, but all typically include some automatic calibration capabilities to reduce algorithm sensitivity to image and camera quality.

Standoff detection, such as the combination of video camera surveillance with machine vision, can detect effluents at the location of source initiation, and thus has the potential for faster detection and significantly lower response times. Cluttered shipboard spaces, however, were expected to pose a serious challenge for video-only standoff detection. The Volume Sensor approach was designed to address this challenge.

Under the Volume Sensor program, three commercial video-based fire detection systems were evaluated in a shipboard environment on the ex-USS Shadwell and in a laboratory setting for their viability. See D. T. Gottuk, et al. Video image fire detection for shipboard use. Fire Safety J. 41(4) (2006) 321-326. This study concluded that the alarm times for the VID systems were comparable to those from spot-type ionization detection systems for flaming fires, but were much faster than either ionization or photoelectric smoke detection systems for smoldering fires. The false alarm rate was undesirably high. One of the most significant challenges to shipboard early warning fire detection with video-based systems is the discrimination of flaming fires from typical shipboard bright nuisance sources such as welding, torch cutting, and grinding.

Two distinct approaches to optical detection outside the visible were pursued. These were: 1) near infrared (NIR), long wavelength video detection (LWVD), which provides some degree of both spatial and spectral resolution and discrimination, and 2) single or multiple element narrow spectral band detectors, which are spectrally but not spatially resolved and operate with a wide field of view at specific wavelengths ranging from the mid infrared (IR) to the ultraviolet (UV). Image detection in the NIR spectral region has been utilized in background-free environments, such as monitoring forest fires from ground installations, see P. J. Thomas. Near-infrared forest-fire detection concept, Appl. Opt. 32 (27) (1993) 5348 and satellites, see R. Lasaponara, et al. A self adaptive algorithm based on AVHRR multitemporal data analysis for small active fire detection. Int. J. Remote Sens. 24(8) (2003) 1723-1749, monitoring of transportation tunnels, see D. Wieser and T. Brupbacher. Smoke detection in tunnels using video images, NIST SP 965, 2001, and surveillance of cargo bays in aircraft, see T. Sentenac, Y. Le Maolt, J. J. Orteu, Evaluation of a charge-coupled device-based video sensor for aircraft cargo surveillance, Opt. Eng. 41(4) (2002) 796-810. Image analysis in conjunction with narrow band filtered (1140 nm) NIR images has been patented as a method for enhancing fire and hot object detection, as previously discussed.

The primary advantages of long wavelength imaging are higher contrast for hot objects and more effective detection of reflected flame emission compared to images obtained from cameras operating only in the visible region. These advantages allow for improved detection of flaming fires that are not in the field of view of the camera. The LWVD system developed for Volume Sensor exploits the long wavelength response of standard CCD arrays used in many cameras (e.g., camcorders and surveillance cameras). This region is slightly to the red (700-1000 nm) of the human ocular response (400-650 nm). A long pass filter transmits light with wavelengths longer than a cutoff, typically in the range 700-900 nm. This increases the image contrast in favor of fire, flame, and hot objects by suppressing the normal video images of the space, and thereby effectively provides a degree of thermal imaging. There is more emission from hot objects in this spectral region (>600 nm) than in the visible. Testing has demonstrated detection of objects heated to 400° C. or higher, see J. C. Owrutsky, et al., Long wavelength video detection of fire in ship compartments. Fire Safety J. 41(4) (2006) 315-320. Thus, this approach to long wavelength imaging is an effective compromise between expensive, spectrally discriminating cameras operating in the mid IR and inexpensive, thermally insensitive visible cameras.

A luminosity-based algorithm was developed to analyze video images for the detection of NIR emission and used to evaluate camera/filter combinations for fire, smoke and nuisance event detection D. A. Steinhurst, et al. Long wavelength video-based event detection, preliminary results from the CVNX and VS1 test series, ex-USS Shadwell, Apr. 7-25, 2003 NRL/MR/6110-03-8733. US Naval Research Laboratory. Dec. 31, 2003. For each incoming video image, the algorithm applied a simple non-linear threshold to the summed, normalized intensity difference of the current video image and a background image established at the start of each test. This approach is similar to one suggested by Wittkopp et al., The cargo fire monitoring system (CFMS) for the visualization of fire events in aircraft cargo holds. Proceedings of AUBE 01:12th International Conference on Automatic Fire Detection. K. Beall. W. Grosshandler. H. Luck, editors. Mar. 25-28, 2001 for fire and smoke event classification with visible spectrum cameras in aircraft cargo holds. The luminosity algorithm serves as the principal detection method for the LWVD system, see U.S. Pat. No. 7,154,400, Owrutsky et al.

The second optical detection method investigated was a collection of narrow band, single element, spectral sensors. Approaches to detect reflected NIR emission from fire sources using narrow band detectors have been previously reported. Atomic emission of potassium at 766 nm has been reported for satellite based fire detection. In addition, a number of UV and IR based flame detectors are commercially available. Narrow band sensors investigated for Volume Sensor included commercial-off-the-shelf (COTS) UV/IR flame detectors, modified so that the individual outputs could be monitored independently, and other sensors operating in narrow spectral bands at visible (589 nm), NIR (766 and 1060 nm), and mid IR (2.7 and 4.3 μm) wavelengths. The spectral bands were chosen to match flame emission features identified in spectra measured for fires with different fuels. In a stand-alone configuration, combinations of the single channels were found to yield results for identifying fires in the sensor's field of view comparable to that of the COTS flame detectors, and with superior performance for fires out of the field of view, several nuisance sources, and certain smoke events. The inclusion of one or more of the single element sensors in Volume Sensor was expected to reduce the false alarms of the integrated system without degrading sensitivity. To achieve this, principal components analysis (PCA) was used to develop a set of algorithms for the spectral sensors to discriminate flaming fires in and out of sensor field of view, smoke from smoldering sources, and high UV-emitting nuisance sources such as welding and torch cutting. The spectral sensors and the PCA-based discrimination algorithms comprise the spectral-based Volume Sensor (SBVS) system.

Another key aspect of the Advanced Volume Sensor was the use of acoustic signatures in the human-audible frequency range for enhanced discrimination of damage control events, particularly flooding and pipe ruptures. Earlier efforts in acoustical leak detection emphasized using ultrasonic technologies for applications in nuclear reactor environments. For Volume Sensor, a representative set of fire and water acoustic event signatures and common shipboard background noises were collected and measured. Measurements were made during testing aboard the ex-USS Shadwell, in a full-scale laboratory test for fires, in a wet trainer for flooding and pipe ruptures, and on two in-service vessels, naval and research, for shipboard ambient noise. The event signatures and noise signals were compared in the time and time-frequency domains. Results indicated that clear differences in the signatures were present and led to the development of first generation algorithms to acoustically distinguish the various events. Flooding and pipe ruptures are typically loud events, and a simple broadband energy detector in the high frequency band (7-17 kHz) with an exponential average, has proven effective even in a noisy environment like an engine room. Further development and testing with linear discriminant models led to algorithms for acoustic-based detection of pipe ruptures, flooding scenarios, fire suppression system activations, gas releases, and nuisance sources such as welding, grinding, and people talking. Microphones and the acoustic detection algorithms make up the acoustic (ACST) sensor system.

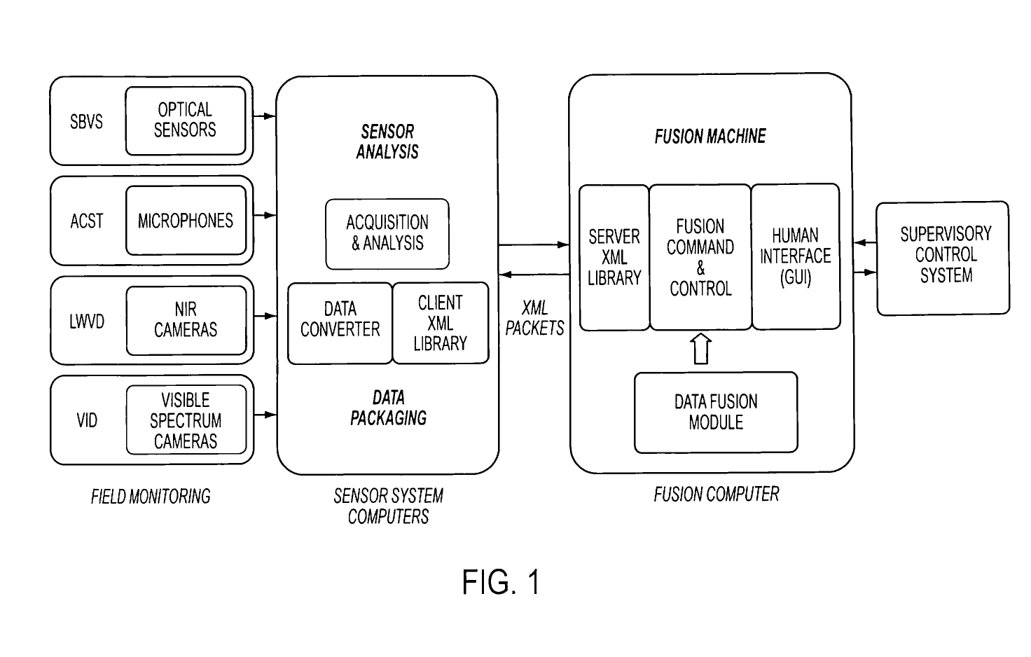

Both the integration of multimodal, complementary sensor systems for fire detection and the performance gains from using data fusion technology are well established in the art. The implementation of the Volume Sensor approach required the consolidation of sensor data from the VID, LWVD, SBVS, and ACST sensor systems with event-specific data fusion. Volume Sensor achieved this by implementing a modular and extensible design that employed a tiered approach to data acquisition and analysis. The Volume Sensor architecture is depicted in FIG. 1. In the diagram, sensor data and situational awareness flow from left-to-right while command and control flows from right-to-left. The labeled boxes in the figure represent the various hardware and software components of Volume Sensor grouped as “field monitoring,” “sensor system computers,” and “fusion system computer.” The box at the far right of the figure, labeled “Supervisory Control System.” represents the interface of Volume Sensor to higher level systems, possibly including a Damage Control Assistant (DCA).

The Volume Sensor consists of several hardware and software components, as well as a unique communications protocol which allows for transfer of data and commands over an ethernet network connecting these components. Hardware components of this system include, but are not limited to: 1) A distributed network of sensors, chosen so as to provide data relevant to the monitoring of events such as fire, smoke, and flooding/pipe rupture: 2) PC-based “sensor machines” that read, aggregate, and format data output by the sensor units: 3) A PC-based “data fusion machine” that collects formatted sensor data and performs calculations to transform this data into event information regarding the compartments in which the sensors are mounted; and 4) Any and all necessary networking hardware to connect components 1, 2, and 3 to each other as well as to the end user of the information output by the data fusion machine, such as the ships damage control display, or automated fire suppression systems.

Each software component is designed to fit within the Volume Sensor communications protocol so as to allow information to pass freely throughout the system. Software components include: 1) Subsystem data acquisition and analysis software resident within the sensor hardware; 2) Software utilized to collect and format acquired sensor data according to the Volume Sensor communications specification; 3) Software utilized to implement algorithms extract relevant features from acquired sensor data; and 4) Software utilized to combine sensor responses into an overall decision rule that identifies and outputs event information.

A schematic diagram of the Volume Sensor is shown in FIG. 1. The Volume Sensor system incorporates the following sensor components: visible spectrum cameras, long wavelength (near infrared) cameras, spectral sensors, and microphones. The Volume Sensor is designed to be capable of incorporating additional types of sensor hardware beyond those used in this implementation, however. Data from each sensor component is processed and controlled by sensor system software, which in turn, interfaces with and transfers data to a fusion machine for aggregation, algorithmic analysis, and distribution to higher level information aggregators or supervisory control systems. The fusion machine also serves as the command and control interface to the Volume Sensor and its component sensor systems

Briefly, the Volume Sensor design for an integrated multisensor system is as follows: Raw sensor data from sensors monitoring compartments are acquired and analyzed by software with algorithms tailored to the sensors, after which sensor data and algorithmic output are packaged and sent on to a fusion machine where they are combined with information from other sensor systems and processed with data fusion decision algorithms. The output of the fusion machine is real-time damage control information for each monitored space in the form of “all clear,” “warning,” or “alarm” signals for several event categories. The fusion machine also serves as the command and control center for the system as a whole. The Volume Sensor design is modular in that the sensor system components, communications, command and control, and data fusion algorithms are implemented in both hardware and software separately. The components work together through specially developed data structures and communications interfaces, which are general enough to allow for the rapid addition of new sensor modalities or data fusion algorithms, or adaptation to new network or system topologies. The Volume Sensor design is also extensible in that the number of sensors being processed is limited by hardware and computer resources, and is not inherently fixed to the number or modality of the selected sensors or data fusion algorithms. By design, limited computer resources can be met by replicating the sensor system/fusion node architecture to accommodate increased monitoring requirements.

Following sensor system selection, two proof-of-concept Volume Sensor prototypes (VSPs) were built and evaluated in the fourth phase of the program, see J. A. Lynch, et al., Volume sensor development test series 4 results—Multi-component prototype evaluation. NRL/MR/6180—06-8934. US Naval Research Laboratory, Jan. 25, 2006.14 and S. L. Rose-Pehrsson, et al. Volume sensor for damage assessment and situational awareness. Fire Safety J. 41(4) (2006) 301-310, both incorporated herein by reference in full. Shipboard testing of the VSPs was performed side by side with two VID-based systems and several spot-type and optical-based commercial systems. The results indicated that the performance of the VSPs was generally comparable to or faster than the commercial systems while providing additional situational awareness of pipe rupture, flooding scenarios, and gas release events, and live video streaming of alarm sources.

Integration of the Volume Sensor components into an effective detection system began with the selected sensors, which were grouped together into heterogeneous arrays referred to as sensor suites. Sensors are grouped into sensor suites in order to simplify installation and network topology as well as to lower eventual costs associated with stocking Volume Sensor components for widespread installation on Navy slips. In the current implementation, each sensor suite contains a microphone, a visible spectrum camera, a bullet camera fitted with a long wavelength filter, four spectral line sensors, and an ultraviolet (UV) sensor. It is possible to incorporate additional sensors that are not part of the original sensor suites (e.g., electrochemical sensors, radiation counters, or even manually operated alarm switches installed in each compartment) although, naturally, the inclusion of new sensor types would necessitate adjustment of the data processing algorithms.

At least one sensor suite is deployed in compartments shipboard. Data from sensor suite(s) are aggregated and processed in a fusion machine at the compartment level. Note that a one-to-one relationship between sensor suites, sensor machines, and a fusion machine is not preserved. Data from sensor components from several sensor suites can be processed by a single sensor machine, which in turn interfaces with a fusion machine. This design is therefore scalable. A fusion machine can aggregate and process data from sensor suites distributed across multiple compartments. Multiple fusion machines can be used to provide Volume Sensor capabilities for either select sections or an entire ship.

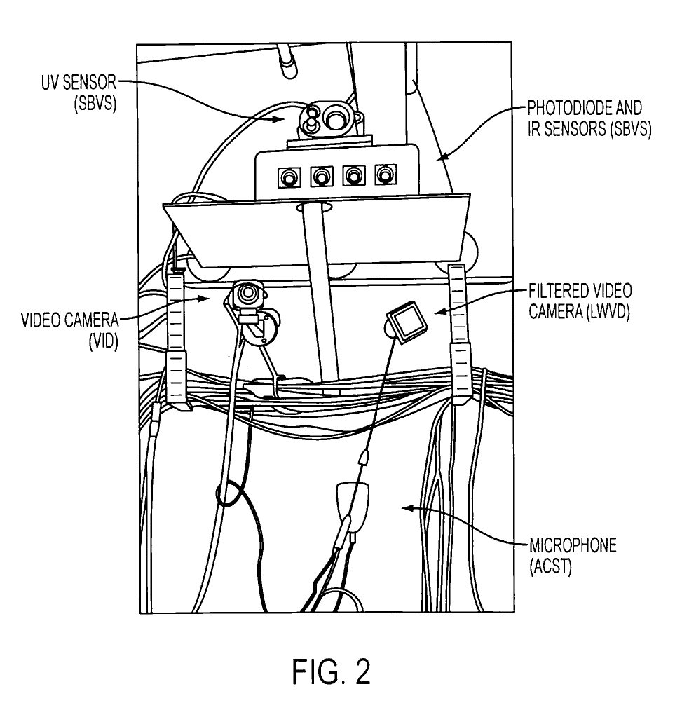

An individual sensor suite was comprised of separate sensors (a video camera, a long wavelength filtered bullet camera, three photodiodes, an IR sensor, a UV sensor, and a microphone) that were installed in close proximity, as shown in FIG. 2. Monitoring was achieved by deploying one or more sensor suites in spaces such as shipboard compartments. Data acquisition of signals in a sensor suite was performed by the sensor's respective system component: VID, LWVD. SBVS, or ACST. The first tier of data analysis was also performed by algorithms implemented in these system components. As a consequence, a sensor system was able to generate both sensor data and sensor algorithm information for data fusion. The NRL-developed sensor systems (LWVD, SBVS, and ACST) passed both sensor data and sensor algorithm information to the fusion machine. Experience with data fusion algorithm development has confirmed that including both raw sensor data and algorithmic information significantly increases the potential for performance gains as more complementary sensing information is provided. The commercial VID systems, however, only passed limited sensor algorithm information, due to the proprietary nature of their software. A one-to-one relationship between sensor suites and sensor computers was intentionally not required and improves the overall system's flexibility and scalability for consolidated sensor configurations and alternative network topologies. Data from sensor components from several sensor suites can be processed by a single sensor machine (e.g., a PC), which in turn interfaces with a fusion machine. The cycle of sensor data acquisition, transfer, data fusion analysis, and output is referred to as the data analysis cycle. Data transfer from sensor machines to the fusion machine was performed in 1 second (1 Hz) increments and thus set the time duration of the data analysis cycle.

A unique communications interface was developed to address the capability need for information transfer between the disparate network of sensing hardware, and PC-based data processing algorithms that comprises the Volume Sensor system. Communication between components of the system can be broken down into three distinct segments: 1) Transmission of data from sensor hardware to the Volume Sensor network; 2) Transmission of sensor data between components of the Volume Sensor network; and 3) Communication between the Volume Sensor network and higher-level shipboard damage control, command, and automated suppression systems.

First, sensor data is collected by the sensor machines and formatted into data packets according to a custom eXtensible Markup Language schema (XML) to allow for maximum flexibility. Each data packet encapsulates information regarding data collection: sensor type, location, and ID, as well as collection time and the sensor data itself. Space for associated event or feature data that will eventually be calculated by downstream data processing algorithms is allocated. Second, these data packets are passed between algorithmic components of the Volume Sensor system, allowing for a uniform and free transfer of information as well as for a well-documented interface between the Volume Sensor system and higher level systems or user interfaces. Data packets are generated at a specific update frequency, with the sensor machines querying the sensor components, formulating the packets, and subsequent data processing occurring as part of each data packet generation cycle, allowing for real-time results.

The efficient storage and transfer of sensor data and algorithm information among the component systems is one challenge that must be met to build an effective multisensor detection system. In Volume Sensor, data storage was accomplished with an efficient tree-based data structure, referred to as the “gestalt data structure.” A single element of sensor data or sensor algorithm output was stored as a floating point value at the finest detail level of the tree, the data level or “leaf.” At the leaf level, a data value was stored together with an identifying string (e.g., flame algorithm) and a category label (e.g. flame) that indicated the data value was relevant to a particular type of event, or that the data value was raw sensor data, which is often relevant to several types of events. Together these three pieces of information formed a data block. Different pieces of sensor information (data blocks) associated with a sensor were grouped together at the next higher level of the tree, the “channel” level. For example, for each camera at the channel level, a VID system provided two pieces of information at the data block level: flame and smoke algorithm outputs. Channels on a sensor computer were grouped together in a channel block at the next higher level of the tree, the “system” level. For example, a sensor machine in the VID system processed video from eight cameras. System blocks from multiple sensor machines were grouped at the highest level of the tree, thus forming the gestalt. One gestalt data structure was filled during each data analysis cycle.

The gestalt data structure had an additional advantage pertinent to data transfer in that it was easily translated into the extensible markup language (XML). In Volume Sensor, data transfer is achieved with XML-based message packets sent on a standard internet protocol (IP) network (i.e., Ethernet) via user datagram protocol (UDP). The networked message packets formed the link between the sensor system computers and the fusion machine shown in FIG. 1. The structure of the XML-based message packets was specified in a communications protocol referred to as the Volume Sensor Communications Specification (VSCS), see C. P. Minor, et al., Volume sensor communication specification (VSCS), NRL Letter Report 6110/054, Chemistry Division. Code 6180, US Naval Research Laboratory, Washington D.C., 20375; Apr. 21, 2004, incorporated herein in full by reference. Message packets in the VSCS protocol consist of information encapsulated by XML tags. A simple system of paired command and response message packets was developed to allow the fusion machine control over the sensor components. A third type of message packet, referred to as a data packet, was used to transfer sensor data and algorithm information from a sensor machine to the fusion machine. During a data analysis cycle, each sensor machine filled and sent a data packet to the fusion machine. The data packet contained data blocks, channel, and system information encoded in an XML version of the gestalt data structure.

A series of sensor specific data processing algorithms is implemented in order to extract relevant features from acquired sensor data. First, in some cases, data processing algorithms are implemented as part of the sensor component itself, such as with COTS fire sensors. These algorithms can provide event information that is predicated upon only one sensing element. Second, pattern recognition algorithms at the sensor machine and data fusion machine level can be incorporated to look to specific time-dependant or multi-sensorial features in the acquired sensor data as well as to make event identifications based on subsets of sensor components. These features and derived event data are extracted in real time and passed to the data fusion algorithms according to the Volume Sensor communication specification.

All sensor data, extracted features and associated event classifications are transmitted to the data fusion machine via a real-time stream of data packets. Within the data fusion machine, an overall decision rule to define various events based on all available data is implemented. This decision rule is constructed through examination of data acquired in laboratory and ship-based test scenarios with prototype systems, in addition to the incorporation of expert knowledge regarding sensor responses to damage control events. The principals of Bayesian belief networks provide a statistical foundation for both designing the decision tree for a given Volume Sensor implementation, and interpreting the results from it in a logical manner.

The fusion machine component of Volume Sensor was a PC-based unit that was responsible for aggregating sensor data, performing algorithmic data fusion analysis, and distributing situational awareness to supervisory control systems or other higher level information aggregators. The fusion machine also served as the command and control unit and external interface to Volume Sensor. The software components that implemented the fusion machine are shown in FIG. 1. The principal component was the command and control (CnC) program, which encapsulated the XML communications libraries and the data fusion module (DFM). The XML libraries were used to encode and decode message packets while the DFM software performed all data fusion-related tasks. The principal human interface was the independently developed supervisory control system (SCS). A graphical user interface (GUI) program was also developed for use in system testing and diagnostics.

Internal and external communications in Volume Sensor are processed through the CnC. The CnC program receives data from and issues commands to the sensor systems, and in turn, receives commands from and sends situational awareness data to the GUI, and to one or more supervisory control systems, when present. All data and command transfers are conducted through a standard TCP/IP network interface using XML-based message packets. XML translation and encoding is performed by custom server-side libraries. Thus, the sensor system software, GUI, and SCS may be physically located anywhere that is network accessible to the fusion machine, or on the fusion machine itself.

Data fusion is performed by algorithms in the DFM software. The DFM is implemented as an object internal to the CnC software itself, with the gestalt data structure serving as the interface between the DFM and CnC components. The DFM object internally employs two other objects for data processing, referred to as sensor suite and data fusion objects. A sensor suite object encapsulates all sensor data and sensor algorithm information pertaining to a given sensor suite, and thus localizes the data in space (sensor suite location) as well as time (data analysis cycle number). A data fusion object encapsulates the data fusion decision algorithms and operates them on selected sensor suite objects. Both objects provide methods for functionality relevant to their purpose. Thus, a sensor suite object can parse the gestalt data structure, extract all sensor information pertaining to its assigned sensors, store the information in a linearized data format, and log this information. A data fusion object can run the data fusion decision algorithms on one or more sensor suite objects, keep track of time dependent features internally, generate real-time alarm and event information for output, and log this information. A sensor suite object typically encapsulates data from a single sensor suite, though other sensor groupings, such as sensors sensitive to flaming fires in magazine compartments, are possible. A data fusion object can process any grouping of sensor suite objects, for example, the sensor suite objects for all sensor suites in a given compartment, or sensor suites in all magazines.

A data fusion object processes data from one or more sensor suite objects with data fusion algorithms and a decision tree, internally tracking events and alarm conditions. The data fusion objects use flags to keep track of events or alarm conditions observed in the current data analysis cycle, persistences to keep track of trends observed in event flags over multiple data analysis cycles, and latches to keep track of events or alarm conditions in steady states. Flags are cleared at the start of each data analysis cycle and then updated by the data fusion decision algorithms. Persistences are incremented or decremented to zero depending on the newly updated flags and current states of latches. New latch states are then set or cleared based on the values of both the flags and persistences. Threat level information, the output of the DFM, is generated from the current states of latches at the end of data analysis cycle. Levels of “all clear,” “warning” or pre-alarm, and “alarm” are indicated through prescribed ranges of real-valued intensities for each damage control event and for all monitored compartments individually. Pattern recognition, statistics, and heuristics may be used for flag, persistence, or latch level decisions. Data from multiple sensor suite objects may be processed sequentially, one sensor suite at a time, or in parallel, for example by taking maximal values over all sensor suites or combining sensor data from several sensor suites, in this way, the data fusion decision algorithms are able to evaluate newly acquired sensor information, track its trends in time, and identify changing or steady states for situational awareness.

Real-time situational awareness was accomplished as follows: Data was gathered by the CnC from the sensor systems and processed internally through the DFM for analysis. The CnC then encoded the output of the analysis with the current data from the sensor components into data packets that were forwarded to the GUI and SCS programs for display. Data packets from the CnC supplied the SCS with current alarm and event information at the end of each data analysis cycle. This included the current threat levels generated from the data fusion decision algorithms for damage control events in all monitored compartments, the current alarm status from the individual sensor algorithms, and the current data values from sensor suites in all monitored compartments. Alarm and event information from the data fusion decision algorithms at the compartment level was considered the output of Volume Sensor. Information at the sensor level was provided for additional situational awareness. For example, when a compartment (i.e., data fusion generated) alarm occurred in the VS5 test series, the SCS displayed a pop-up window containing a real-time video stream from the camera located nearest to the alarm source, as determined by the data fusion decision algorithms. The SCS also supplied detailed status and alarm information windows for all compartments and sensor suites on demand, as well as video streams from all visible spectrum cameras.

The fusion machine software components were developed in Microsoft's Visual Studio .NET (2003) environment for use with the Windows XP Professional operating system. The CnC program and the DFM software were written in the C++ language. The GUI program was written in Microsoft's C# language. The XML libraries that implement the VSCS protocol were written in the standardized C language for cross-platform compatibility and were developed by Fastcom to Volume Sensor specifications.

Volume Sensor presents a difficult challenge for conventional pattern recognition algorithms employed for data fusion. The combination of inexpensive sensors and a dynamic, industrial background leads to noisy signals with large variations, and the dynamic signal responses to damage control events from incipient (smoldering cable bundle) to catastrophic (magazine fire) further hinders event recognition. Regardless, pattern recognition can potentially offer enhanced classification performance and faster times to alarm. Techniques investigated for this effort included feature selection, data clustering, Bayesian classification, Fisher discriminant analysis, and neural networks. For example, event model predictors developed from an event database using probabilistic neural nets (PNN) and linear discriminant analysis (LDA) were investigated for event classification. These techniques were chosen for their small number of parameters, their probabilistic output, and their prior success in classifying data from real-time chemical sensors. Both techniques were effective (>85% correct) at event classification with sensor data restricted to the extracted background and event regions, but were only marginally effective (<65% correct event classification) when applied in real-time simulations with the complete data set. The lack of robustness indicated that these pattern recognition techniques poorly modeled the variability and complexity of the real-time sensor responses.

For this reason, a Bayesian statistical framework was used to develop a robust event classifier capable of performing data fusion for Volume Sensor. An event database was used to generate event-specific frequency tables of individual binned sensor responses. The frequency tables were used to calculate event likelihoods from real-time sensor inputs. A test statistic based on an odds ratio of event-specific Bayesian posterior probabilities that incorporated these likelihoods was used to quantify threat levels for nine event classes: fire, bright nuisance (i.e. welding or torch cutting), grinding, engine running, water (flood), fire suppression system activation, gas release, background, and people working. A preliminary implementation of the classifier was incorporated into the DFM.

The Volume Sensor concept is a remote, optical-based detection system that uses cameras already planned for new ships. Other sensor technologies augment the cameras for enhanced situational awareness. The goal was to make an inexpensive, remote detection system with faster response times to damage control events such as smoldering fires than can occur with diffusion limited point or spot-type smoke detectors. Video image detection is the main detection method with the other sensing technologies being used to enhance and expand on the video detection capabilities. Full-scale laboratory and shipboard tests were conducted to develop a database of events. These tests assisted in the selection of the subsystems that were incorporated in the Volume Sensor. The Volume Sensor prototype consists of commercial video image detection systems in the visible spectrum, long wavelength video image detection in the 700 nm to 1000 nm range spectral sensors in the ultraviolet (UV), visible, near infrared (NIR), and mid-IR ranges, and microphones in the human-audible frequency range.

The primary advantages of long wavelength imaging are higher contrast for hot objects and more effective detection of reflected flame emission compared to images obtained from cameras operating only in the visible region. This allows for improved detection of flaming fires that are not in the field of view of the camera. This approach to LWVD is a compromise between expensive, spectrally discriminating cameras operating in the mid IR and inexpensive, thermally insensitive visible cameras. The LWVD system exploits the long wavelength response of standard CCD arrays used in many cameras (e.g., camcorders and surveillance cameras). This region is slightly to the red (700-1000 nm) of the ocular response (400-650 nm). A long pass filter transmits light with wavelengths longer than a cutoff, typically in the range 700-900 nm. This increases the contrast for fire, flame, and hot objects and suppresses the normal video images of the space, thereby effectively providing some degree of thermal imaging. There is more emission from hot objects in this spectral region than in the visible (<600 nm). Testing has demonstrated detection of objects heated to 400° C. or higher. A simple luminosity-based algorithm has been developed and used to evaluate camera/filter combinations for fire, smoke and nuisance event detection.

The second optical detection method investigated was a collection of narrowband, single element spectral sensors. These included commercial-off-the-shelf (COTS) UV/IR flame detectors modified so that the individual outputs can be monitored independently, and other sensors operating in narrow bands (10 nm) at visible (589 nm), NIR wavelengths (766 and 1060 nm), and mid IR wavelengths (2700 nm (2.7 μm) and 4300 nm (4.3 μm)). The spectral bands were chosen to match flame emission features identified in spectra measured for fires with different fuels. In a stand-alone configuration, combinations of the single channels were found to yield comparable results as the COTS flame detectors for identifying fires, both in and out of the field of view, and better performance for detecting some smoke events and several nuisance sources. It is expected that the inclusion of one or more of the single element optical sensors into the integrated system will significantly improve the detection of flaming sources and significantly reduce the number of false alarms for the integrated system without degrading the sensitivity.

Another key aspect of the Volume Sensor uses acoustic signatures for enhanced discrimination of damage control events, particularly flooding and pipe ruptures. A representative set of fire and water acoustic event signatures and common shipboard background noises have been measured. Measurements were made aboard the ex-USS Shadwell, in a full-scale laboratory test for fire, in a Navy wet trainer for flooding/ruptures, and on two in-service vessels, naval and research, for shipboard ambient noise. The event signatures and noise signals were compared in the time and time-frequency domains. Results have indicated that clear differences in the signatures were present and first generation algorithms have been developed to distinguish the various events. Flooding and pipe ruptures are loud events, and a simple broadband energy detector, in the high frequency band 7-17 kHz with an exponential average, has been effective even in a noisy environment like an engine room (Wales et al. 2004). The algorithms developed for the Volume Sensor Prototype use the mean level and variance with time for discrimination of events. Some nuisance events, like grinding, cutting torches and arc welding, are also loud, but have level variations with time that distinguish them from flooding and pipe rupture events. Fire events are the quietest, though even here, some distinctive features have been observed.

Pattern recognition and data fusion algorithms have been developed to intelligently combine the individual sensor technologies with the goal of expanding detection capabilities (flame, smoke, flood, pipe ruptures, and hot objects) and reducing false positives. Enhanced sensitivity, improved event discrimination, and shorter response times are the milestones for success. The algorithms being developed capture the strengths of specific sensor types and systems while minimizing their weaknesses.

The successful components have been tested and integrated into a system. Visual images and machine vision are used for motion and shape recognition to detect flaming and smoldering fires, pipe and hull ruptures, and flooding. Spectral and acoustic signatures are used to detect selected events, like arc welding and pipe ruptures, and to enhance event discrimination. Long wavelength image analysis provides early detection of hot surfaces, high sensitivity for ignition sources, and the capability of detecting reflected fire emission, thereby reducing the reliance on line of sight in VID systems (i.e., it provides better coverage of a space or fewer cameras). FIG. 2 shows the graphical user interface for the prototype system.

Volume Sensor can monitor spaces in real time, provide pre-alarm and alarm conditions for unusual events, log and archive the data from each subsystem, and archive and index alarms for easy recall. The communications interface that is used to move information between components is based on an extensible data format with XML-based message packets for easy implementation on a wide variety of networks. A tiered approach to multisensor integration with data fusion is employed. Sensor data and algorithm information are transferred from the sensor subsystems to a central data fusion node for processing. Algorithms first process the raw data at the sensor subsystem level and then in the fusion node, combine and analyze data across the sensor subsystems in a decision tree incorporating expert knowledge and pattern recognition for event pre-alarm conditions. A pre-alarm triggers a second level of more sophisticated algorithms incorporating decision rules, further pattern recognition, and Bayesian evaluation specific to the event condition. The output of this latter tier is then passed to an information network for accurate, real-time, situational awareness.

The Volume Sensor employs an innovative modular design to enhance flexibility and extensibility in terms of both the number of deployable sensor systems and the types of detectable events. The components of the modular design include: (1) A general communications interface, based on data packet structures and implemented in the extensible markup language (XML). The interface includes separate protocols for command and control and data transfer for the sensor system/CnC interface and the CnC/information aggregator interface. The communications interface may be easily implemented for operations over any common network technologies including secured and wireless; (2) A sensor gestalt data structure format designed for efficient sensor data encapsulation and communications, (3) A Data fusion object data structure format for efficient algorithmic processing of sensor data; (4) Data fusion algorithms implemented as a standalone class library designed with a simple interface that processes sensor data packaged in a sensor gestalt format; and (5) Modular design of the data fusion algorithms incorporates a tiered approach to processing to allow for multi-level analysis, for example, pattern recognition algorithms feeding data fusion algorithms in a decision tree, and for extensibility to incorporate new algorithms for new events or sensor types.

The Volume Sensor tests included a variety of typical shipboard fire, nuisance, and pipe rupture events, and were designed both to assess the developmental progress of the prototype system. In addition, the prototype detection capabilities and false alarm rates were compared to stand alone COTS fire detection systems that included two video-based and several spot-type detection systems.

As early warning units, each of the Volume Sensor prototypes and their component sensor subsystems performed very well. Sensor data and local sensor analysis was transmitted to the fusion machines at one-second intervals with virtually no footprint on a 100 Mbs Ethernet network. Testing revealed that processing on the PC-based fusion machines (P4 class) remained smooth in real-time.

One of the most significant challenges to shipboard early warning fire detection with video-based systems is the discrimination of the flaming fires from typical shipboard bright nuisance sources like welding, torch cutting, and grinding. The LWVD sensor system was consistently the most sensitive system to flaming fires, but exhibited a similar sensitivity to bright nuisances. Both commercial VID systems also displayed this behavior with flaming fires and bright nuisances, though at a lesser sensitivity than LWVD. Thus, neither system could be relied on for accurate discrimination of flaming fires and nuisance sources. For this task, the suite of spectral sensors was incorporated in two ways. First, a set of effective local detection algorithms were developed for the spectral-based sensor system to detect emission signatures typical of welding events, and flaming fires in and out of the field of view of the sensor suite. Second, the data fusion flame detection algorithm intelligently combined the outputs from the light sensitive video systems with the emission signatures from the spectral systems to quite successfully discriminate flaming fires from bright nuisances.

The commercial VID systems were quite effective in the detection of smoldering source events, with those not seen first by a VID system, eventually seen by the spectral sensor system, or picked Lip by smoke blooming on compartment lights with the LWVD system. As a consequence, the Volume Sensor prototypes relied almost entirely on the VID systems for smoldering detection, and most of the false positives (nuisance alarms) given by the prototypes were due to false positives in the VID systems.

Finally, the acoustic sensor system performed very well in the detection of pipe rupture-induced flooding events and gas leak events, and reasonably well in the detection of nuisance sources. The data fusion flooding algorithm of the Volume Sensor prototypes combined the output of the acoustic sensor system with those of the spectral and LWVD systems to discriminate against noisy shipboard nuisances like welding, torch cutting, and grinding. These algorithms also performed very well.

The prototypes detected all the flaming and smoldering fires, achieving 100% correct classification rates. This is better performance than the four commercial systems. In addition, the prototypes had higher nuisance source immunity than the commercial VID systems and the ionization smoke detector. The photoelectric smoke detector had better nuisance rejection than both prototypes; however, this was achieved at a cost. The detection rate for the photoelectric smoke detection system, for flaming fires was much worse, detecting only 65% of these fires. The prototypes also have capabilities that the fire detection systems do not have. The Volume Sensor prototypes correctly classified 94% of the pipe rupture events, missing only one test with a weak flow rate.

Two prototype systems based on the Volume Sensor concept have been built and tested in a shipboard environment simultaneously with commercial VID detection systems and spot-type fire detection systems. The results of these tests indicated that the Volume Sensor prototypes achieved large improvements in the sensitivity to damage control events, significant reduction in the false alarm rates, and comparable or faster response times for fire detection when compared to the other commercial systems. The primary exception was that ionization smoke detectors were generally faster than the Volume System for flaming fires. The functionality and performance of the Volume Sensor prototype system has been successfully demonstrated. The components detected event conditions and communicated the alarms and alarm times to the Fusion Machines. In addition, both Volume Sensor prototypes outperformed the individual sensor system components in terms of event detection and nuisance rejection. The Fusion Machine incorporated data fusion algorithms that synthesized information from the sensor sub-system components to improve performance, particularly in the area of nuisance source rejection. The Fusion Machine performed very well, demonstrating the ability to discriminate against nuisance sources while detecting smoldering and flaming fires and pipe rupture sources. Much of the improved nuisance rejection capability for the fusion systems was attributed to the speedy and accurate spectral based welding detection algorithm and the reliance on multi-sensory data fusion for flaming fire detection. The inclusion of the pipe rupture algorithm in the data fusion provided excellent classification results for these events with nearly no false positives. The improved data fusion nuisance rejection algorithm and increased persistence requirements for all data fusion algorithms reduced spurious false and incorrect alarms and kept the nuisance rejection performance of the Volume Sensor prototypes at a much higher level than that of the commercial systems.

A total of eight sensor suites were built and used to instrument the six compartments. Each of the eight sensor suites contained a CCTV video camera (Sony SSC-DC393), a long wavelength camera (CSi-SPECO CVC-130R (0.02 Lux) B&W camera with a LP720 filter), a microphone (Shure MX-393 in suites 1-7 or Shure MX-202 in suite 8), and a suite of spectral sensors consisting of three Si photodiodes with interference filters at 5900, 7665, and 10500 Å, two mid IR detectors at 2.7 μm and 4.3 μm, and a UV unit. The signals from each video camera were connected to the two commercial VID systems. The signals from the long wavelength cameras, microphones, and spectral sensors were connected to the LWVD system, the ACST system, and the SBVS system, respectively.

The signal pathways for the sensor suite video cameras were as follows: The Sony CCTV video cameras were split four ways via AC-powered video splitters and connected to (1) Fastcom's Smoke and Fire Alert (version 1.1.0.600) VID detection system, (2) axonX's Signifire (version 2.2.0.1436) VID detection system, (3) eight Axis 241S video servers, and (4) various PC-based digital video recorders (DVRs) [45]. Note that the Axis video servers converted the video signals to a compressed format suitable for transmission over TCP/IP to the supervisory control system and that 10 DVRs were used to record video from the visible spectrum and long wavelength cameras (five of each) in compartments where sources were activated. Camera to DVR connections were reconfigured between tests. The long wavelength cameras were split two ways via AC-powered video splitters and connected to (1) eight Pinnacle Studio Moviebox DV Version 9 video analog-to-digital converters and (2) various PC-Based DVRs.

The Fastcom Smoke and Fire Alert fire detection software (version 1.1.0.600) was purchased and installed on a standard Pentium IV class PC running the Microsoft Windows 2000 operating system and processed video from all eight Sony visible spectrum cameras. The axonX Signifire fire detection software (version 2.2.0.1436) was purchased and installed on a standard Pentium IV class PC running the Microsoft Windows XP (Home edition) operating system. The axonX PC also processed video from all eight Sony visible spectrum cameras. In both VID systems, video signals were routed from the splitters to 4-input frame grabber PCI bus cards (Falcon Eagle) for digitization. Two frame grabber cards were installed in each VID PC to accommodate eight cameras. Both systems were configured to operate with the manufacturer's recommended settings, as determined during prior shipboard and laboratory testing. Software (“middleware”) implemented the VS communications protocols and allowed their fire detection systems to interface with Volume Sensor.

Video signals from the long wavelength cameras were routed from the splitters to the Pinnacle analog-to-digital converters, digitized, and processed by the LWVD data acquisition and analysis software. One Pinnacle was used for each camera's video signal. The Pinnacles output digitized still video images at 29.94 frames per second to a standard IEEE 1394 (Firewire) interface for input to a PC. The LWVD software was installed on eight of the Pentium IV class, PC-based DVRs, all of which were running the Microsoft Windows XP (Professional edition) operating system. The LWVD software also implemented the VS communications protocols.

Signals from the spectral sensors were routed to three National Instruments (NI) cFP-2000 Fieldpoint units for data acquisition and subsequent processing by the SBVS analysis software. Each of the Fieldpoint units contained three 8-input analog input units (NI cFP-AI-110) and one 8-input universal counter module (NI cFP-CTR-502). The Fieldpoint units transferred the sensor data to the SBVS analysis software using TCP/IP over an Ethernet network. The SBVS software was installed on eight of the PC-based DVRs in parallel with the LWVD software and also implemented the VS communications protocols.

Signals from the acoustic microphones were routed directly to analog-to-digital cards on the ACST sensor system PC's. Two Pentium IV class PC's running the Linux operating system each handled four acoustic microphones via the ACST data acquisition and analysis software. Signal digitization was performed locally by a 24 bit D/A card. The ACST software also implemented the VS communications protocols.

The software implementing the data fusion decision algorithms, command and control, and the graphical user interface was installed on two Volume Sensor fusion machines, one for each prototype. The fusion machines were Pentium IV class PC's running the Microsoft Windows XP (Professional edition) operating system. The sensor systems (VID. LWVD, SBVS, and ACST) and the supervisory control system interfaced with the fusion machines via TCP/IP on a standard Ethernet network. Each of the Volume Sensor prototypes received identical information from the LWVD. SBVS, and ACST sensor systems, but received different sensor information from the VID system component. Volume Sensor prototype 1 (VSP1) received and processed sensor data from the LWVD, SBVS. ACST, and Fastcom VID systems. Volume Sensor prototype 2 (VSP2) received and processed sensor data from the LWVD, SBVS, ACST, and axonX VID systems. VSP1 interfaced with the supervisory control system during the first week of the test series; VSP2 during the second week.

The two VID systems (Fastcom and axonX listed above) also analyzed video data from all compartments with their own algorithms and logged alarms independently from Volume Sensor. These algorithms differed slightly in their alarm criteria from those the VID systems used as part of the Volume Sensor prototypes. The Fastcom system employed stricter criteria for flame and smoke alarms while the axonX system was capable of resetting alarms and background levels dynamically. Three different spot-type detectors from Edwards Systems Technologies were also tested. These were the ionization (EST SIGA-IS), multicriteria (EST SIGA-IPHS), and photoelectric (EST SIGA-PS) fire detection systems. The EST detectors were grouped for mounting into clusters containing one detector of each type. A total of seven clusters were used to instrument five of the test spaces. All EST detectors were used at the manufacturer recommended “Normal Sensitivity” setting, exact values of which are given in Lynch, et al.

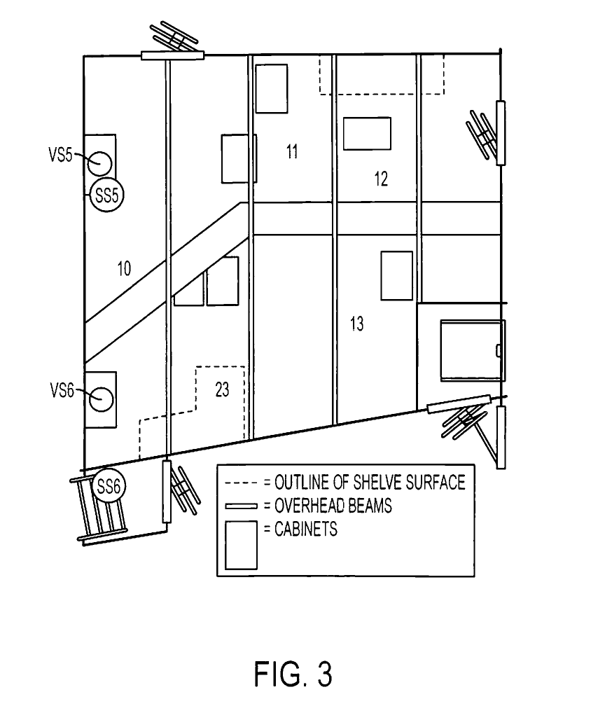

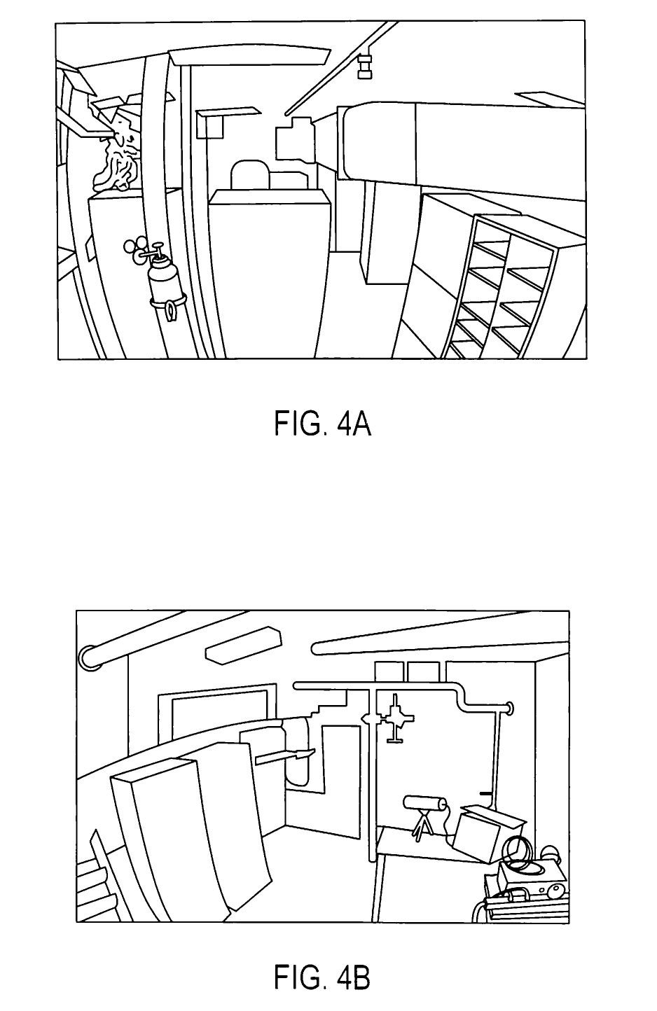

Six compartments aboard the ex-USS Shadwell were simultaneously employed as test spaces for VS5 Test Series. These included two magazine spaces, an electronics space, an office space, a passageway, and a mock-up of a missile launch space that spanned four decks. The compartments varied in size, shape, contents and obstructions. Dimensions of the compartments are provided in Table 1. Note that the electronics space was entirely contained within the third deck magazine. Table 1 provides the overall dimensions of the third deck magazine, but the area and volume have been adjusted to account for the electronics space. The office and magazine spaces had beams with an approximate depth of 18 cm spaced at intervals of 0.6 m in the overhead. These spaces were also populated with various large, free-standing obstructions. Beams are particularly challenging to overhead mounted spot-type detectors that rely on effluent drift for detection. Free-standing obstructions are more challenging for video-based, volume sensing systems as they can greatly impede effluent sight lines. The passageway was long, narrow, dim, and partially obstructed midway by a hatch kept open during testing. The PVLS space contained launch canisters mocked tip from metal ductwork and steel gratings for floors at three decks. A diagram of one of the test spaces, the operations office, is displayed in FIG. 3 and shows the locations of ductwork, overhead beams obstructions, and sensors. Two sensor suites, labeled “SS5” and “SS6,” were located in the operations office. Views from the visible spectrum cameras in sensor suites 5 and 6 are provided in FIG. 4.

TABLE 1
Descriptions of compartments

| | | | | VSP | |
|---|---|---|---|---|---|
| | Area | Volume | | Sensor | EST |
| Compartment | (m²) | (m³) | L × W × H (m) | Suites | Clusters |
| 3^{rd} deck magazine | 31.3 | 99 | 6.1 × 8.1 × 3.0 | 2 | 2 |
| Electronics space | 18.1 | 49 | 4.9 × 3.7 × 2.7 | 1 | 1 |
| 2^{nd} deck | 22.0 | 64 | 6.1 × 3.6 × 3.0 | 1 | 1 |
| magazine | | | | | |
| Operations office | 33.0 | 96 | 6.1 × 5.4 × 3.0 | 2 | 1 |
| Passageway | 18.5 | 55 | 16.8 × 1.1 × 3.0 | 1 | 2 |
| PVLS | 25.0 | 229 | 8.4 × 3.0 × 9.1 | 1 | 0 |

The number of VSP sensor suites placed in each compartment is listed in Table 1. Sensor suites were mounted on the bulkhead walls, located at heights varying from 1.88 m in operations office (SS5), to 2.57 m in the third deck magazine (SS3), to the overhead for the PVLS space (SS8). Specific location information for each of the sensor suites is available in Lynch, et al. The number of EST clusters placed in each compartment is also listed in Table 1. EST detectors were mounted in the overhead at locations generally near the center of the compartments. Though the compartment distribution and location of the EST clusters was not identical to that of the VSP sensor suites (for example, no EST detectors were located in the PVLS space), the placement of detectors, cameras, and sensor suites adhered to manufacturer's guidelines for the systems. Exact locations are given in Lynch, et al.

The Volume Sensor prototypes and commercial detection systems were evaluated in test scenarios using typical shipboard damage control and nuisance sources. Damage control sources included flaming and smoldering fires, pipe ruptures leading to flooding scenarios, and gas releases. Common shipboard combustibles were used as fuels for fire scenarios. Open pipes, gashed pipes, and pipes with various sprinkler nozzle heads were used in pipe rupture, flooding, and suppression system scenarios. Air bottles, nitrogen bottles, and a self contained breathing apparatus (SCBA) mask were used in gas release scenarios. Nuisance sources represented typical fire-like shipboard activities such as welding, grinding, and torch cutting steel plates, as well as several other sources suspected to cause nuisance alarms in Volume Sensor components, for example, combustion engine operation, and television and radio use. The number of tests conducted and the descriptions of various test scenarios are shown in Table 2. Replicate scenarios were not generally performed sequentially in the same compartment. Incipient size sources were generally used to challenge the detection abilities of all the sensors, and in particular, to test early warning capabilities. Further details for all sources and test scenarios are available in Lynch, et al.

TABLE 2
Descriptions of source scenarios

| Tests | |
|---|---|
| | Fire Scenarios |
| 10 | Flaming cardboard boxes with polystyrene pellets |
| 4 | Flaming IPA spill fire and trash bag |
| 6 | Flaming shipping supplies |
| 6 | Flaming trash can |
| 2 | Flaming wallboard |
| 8 | Heptane pan fire |
| 2 | Hot metal surface, IPA spill under slanted cab door |
| 2 | Painted bulkhead heating |
| 9 | Smoldering cable bundle |
| 1 | Smoldering cardboard boxes with polystyrene pellets |
| 4 | Smoldering laundry |
| 4 | Smoldering mattress and bedding |
| 8 | Smoldering oily rags |
| | Suppression, Water, and Gas Scenarios |
| 2 | Sprinkler/mist system 250 psig (AM-4) |
| 1 | Water aerosol - mist 60 psig |
| 1 | Pipe rupture - mist 60 psig |
| 1 | Pipe rupture - gash 40 psig |
| 1 | Pipe rupture - gash 60 psig |
| 3 | Pipe rupture - open pipe 120 psig |
| 1 | Pipe rupture - sprinkler 60 psig |
| 1 | Pipe rupture - sprinkler 120 psig |
| 2 | Pipe rupture - 9 hole 250 psig |
| 1 | Pipe rupture - 2″ gash 120 psig |
| 2 | Pipe rupture - 10″ gash 120 psig |
| 4 | Gas release - Air (constant flow) |
| 1 | Gas release - Air (bursts) |
| 4 | Gas release - N2 100 psig |
| 5 | Gas release - N2 250 psig |
| 3 | SCBA |
| | Nuisance Scenarios |
| 1 | Aerosol |
| 4 | AM/FM radio, cassette player, TV |
| 1 | Engine exhaust |
| 1 | Flash photography |
| 4 | Grinding, painted steel |
| 1 | Heat gun |
| 3 | Toaster, normal toasting |
| 3 | Space heater |
| 1 | Spilling metal bolts |
| 6 | Torch cutting, steel |
| 7 | People working |
| 2 | Waving materials |
| 7 | Welding |

A standard test procedure was adhered to: approximately 4 minutes of ambient background data collection, followed by exposure to a target damage control or nuisance source, and then ventilation of the space to remove all smoke. During a test, sources were activated concurrently in selected compartments, concurrently in the same compartment, or consecutively in the same compartment. Source exposure was terminated when a source was fully consumed, or when all sensor systems were either in alarm or showed no change in detection due to quasi-steady state source conditions. Compartments were sealed off during tests and ventilation was maintained at a typical shipboard level of 4 to 5 air changes per hour. Time synchronization was updated daily for all sensing systems and source initiation, source cessation, and sensor system alarm times were recorded in time-of-day format.

The measures of performance that were used to evaluate the Volume Sensor prototypes were: 1. The ability of the VSPs to operate in multiple compartments; 2. The ability of the VSPs to correctly discriminate sources in compartments varying in size, shape, and content (obstructions); 3. The ability of the VSPs to correctly discriminate multiple events occurring consecutively within a compartment or simultaneously in multiple compartments; 4. The ability of the VSPs to successfully integrate with a supervisory control system; The correct classification of damage control (fire, water and gas release) and nuisance sources; and 6. The speed of response (time to alarm) to fire, water and gas release sources.

Measures (1) through (4) were used to evaluate the general functionality of the multicomponent VSPs. Measures (5) and (6) were used to quantify the performance of the VSPs in terms of speed and accuracy. In addition, measures (5) and (6) were used to compare the performance of the VSPs with the two commercial VID systems and spot-type ionization, photoelectric, and multicriteria fire detectors.

In terms of performance measures (1) through (4), which pertain to general functionality, the VSPs and their component sensor systems performed very well. Sensor data were accurately and consistently transmitted from the various sensor computers to the fusion machines at one-second intervals with virtually no footprint on the connecting 100 Mbps Ethernet network. During testing, the Pentium IV class PC-based fusion machines used in the prototypes demonstrated adequate processing capabilities, running smoothly and remaining responsive in real-time operation. Alarm information and situational awareness was transmitted accurately and promptly to supervisory control system.

The VSPs and their component sensor systems also performed very well in their intended function as early warning devices. The VSPs were able to successfully monitor multiple compartments simultaneously and to distinguish multiple damage control and nuisance scenarios, including consecutive nuisance-to-fire transitions, in those compartments despite their varying size, shape, and degree of view-obstruction. Further, the VSPs were able to identify the diffusion of smoke between compartments and detect pipe ruptures, fire suppression system activations, and gas releases.

The discussion that follows will focus on measures of performance (5) and (6), which are classification accuracy and time-to-alarm, for the two VSPs. The performance of the VSP systems will be compared to that of the two VID systems and three spot-type detectors that were tested alongside the VSPs. The results presented here for the VSP systems were obtained from an in-depth analysis of alarm times in the VS5 test series and therefore differ from the preliminary results of Lynch, et al. Correct classification rates for damage control and nuisance sources improved for the VSPs after a more thorough examination of simultaneous and consecutive test scenarios. Results for the commercial systems were compiled from Lynch, et al.

Source classification is achieved by associating the alarm times generated by a detection system with a damage control or nuisance source event. With simultaneous, overlapping, and consecutive damage control and nuisance sources in six compartments, the complexity of the VS5 test series presented a number of classification challenges. In the discussion that follows, “sources” refers to damage control and nuisance scenarios initiated by test personnel, “events” refers to damage control and nuisance scenarios detected by sensor systems. Source and event totals may differ due to false positives. Tables documenting the test matrix and alarm times have been excised for brevity.

A summary of the source classification results is presented in Table 3, which lists the percent correct classification of each detection system by source type. The detection systems are labeled in the first row of table. The VSPs are listed in the “VSP1” and “VSP2” columns, the Fastcom Smoke and Fire Alert video system in the “VIDF” column, the axonX Signifire video system in the “VIDA” column, and the EST ionization, photoelectric, and multicriteria systems in the “ESTI,” “ESTP,” and “ESTM” columns, respectively. The source types are listed in the first column of the table. Fire sources are presented separately as “flaming” fires and “smoldering” fires on the second and third rows, and the combined results represented as “fire sources” on the third row. Nuisances are listed next on the fourth row, followed by the combined results for all fire and nuisance sources on the fifth row. For the VSP systems only, water sources, representing combined results for pipe rupture, flooding, and suppression sources are listed in the seventh row, followed by gas release sources on the eighth row.

TABLE 3
Percent correct classifications to damage control and nuisance sources

| | VSP1 | VSP2 | VIDF | VIDA | ESTI | ESTP | ESTM |
|---|---|---|---|---|---|---|---|
| Event Type | (%) | (%) | (%) | (%) | (%) | (%) | (%) |
| Flaming | 95 | 100 | 91 | 95 | 88 | 75 | 88 |
| Smoldering | 75 | 81 | 65 | 89 | 63 | 93 | 78 |
| Fire sources | 86 | 92 | 80 | 92 | 76 | 83 | 83 |
| Nuisance | 88 | 87 | 51 | 63 | 71 | 92 | 83 |
| Fire & | 87 | 90 | 64 | 79 | 74 | 86 | 73 |
| nuisance | | | | | | | |
| Water | 94 | 88 | n/a | n/a | n/a | n/a | n/a |
| Gas release | 53 | 53 | n/a | n/a | n/a | n/a | n/a |

The calculated “percent correct classification” represents the ability of the detection system to correctly classify source events within the test series. The percent correct classification for a given source type is calculated for each detection system as the percent ratio of the number of correctly classified detections to the number of opportunities for detection. i.e., the number of tests with that source type. In the case of nuisance sources, a correctly classified detection results in no alarm. For all other sources, a correctly classified detection is an alarm appropriate to the source.

Table 4 provides a summary of the number of opportunities for detection for VSP1, VSP2, the VID, and the EST systems for each of the source types listed in Table 3. Entries in Table 4 reflect the number of tests for which each system was available. The actual number of sources activated by test personnel of each source type is listed in the first column of Table 4. VSP1 and the VID systems were available for all tests. VSP2 was rendered unavailable during the last test of VS5 due to a fusion machine system freeze caused by a software error that was not related to the VSP or its components and thus exhibits slightly reduced totals. The EST detectors were not available for the tests 1 and 37 and were not installed in the PVLS. Tables 3 and 4 document the classification capabilities of the detection systems irrespective of hardware failures and therefore represent the “best case” performance scenario.

TABLE 4
Number of detection opportunities for damage
control and nuisance sources

| | Sources | VSP1 | VSP2 | VID | EST |
|---|---|---|---|---|---|
| Event Type | (#) | (#) | (#) | (#) | (#) |
| Flaming | 38 | 38 | 37 | 38 | 33 |
| Smoldering | 28 | 28 | 27 | 28 | 27 |
| Fire sources | 66 | 66 | 64 | 66 | 60 |
| Nuisance | 41 | 41 | 39 | 41 | 37 |
| Fire & | 107 | 107 | 103 | 107 | 97 |
| nuisance | | | | | |
| Water | 16 | 16 | 16 | n/a | n/a |
| Gas release | 17 | 17 | 17 | n/a | n/a |

Entries for fire scenarios in Table 3 reflect the different monitoring capabilities of the detection systems. For example, once an EST detection system (ion, photo or multi) alarms to a source in a compartment, no new alarms can be generated until the EST system is manually reset. Thus, if an EST system alarms (incorrectly) to a nuisance event such as welding, then the system cannot detect a subsequent accidental fire in that compartment, a fire scenario tested repeatedly in the VS5 test series. The VSP and VID systems can detect fires as either flaming or smoldering, and thus have more resilience to nuisance-induced false alarms as one detection algorithm may have alarmed incorrectly while another may still be actively monitoring the compartment. Such a feature was not available to the EST systems. The VSP systems also incorporate additional nuisance detection algorithms that block spurious alarms from fire-like nuisance sources such as welding, grinding, and torch cutting.

For fire sources. VSP1 and VSP2 achieved correct classification rates of 86% and 92% of the sources, respectively (corresponding to false negative rates of 14% and 8%). The VSP systems identified 95% or more of the flaming sources, and more than 80% of the smoldering sources. VSP1 failed to identify two flaming and three smoldering sources in the passageway, and one smoldering source in the PVLS, most likely due to high ventilation and dim lighting in the passageway and the unusually elongated geometry of both spaces. VSP1 also failed to identify one smoldering source in each of the magazine spaces. VSP2 correctly identified all flaming sources, but missed the same smoldering sources in the passageway and PLVS as VSP1. The difference in performance between VSP1 and VSP2 for fire sources is a direct indication of the difference in performance between the two VID systems. Compared to the commercial systems, VSP2 and VIDA were the most effective detection systems for flaming sources. The photoelectric spot-type detector and the VIDA system identified more smoldering sources (93% and 89%, respectively) than the VSP systems, and VIDA detected 95% of flaming sources, equivalent to VSP1. All other commercial systems had lower correct classification rates than the VSPs. For fire sources overall, the best performers were VSP2 (92%) and VIDA (92%), followed by VSP1 (86%). The photoelectric system was less able to identify flaming sources (75%): the Fastcom VID system was less able to identify smoldering sources (65%).

Correct classification rates by VSP1 and VSP2 for nuisances sources were 88% and 87%, respectively (corresponding to false positive rates of 12% and 13%) and consistent with observations that higher detection rates for fires sources (here, VSP2) are commensurate with higher false positives. The VSP1 flame and smoke detection algorithms incorrectly classified one welding, two torch cutting, and one toaster source as fire events. The VSP2 flame and smoke detection algorithms incorrectly classified the same welding and torch cutting sources, plus one additional torch cutting source as fire events. The performance differences again are due to the commercial VID systems. The welding and torch cutting sources that were missed by both VSPs, however, were due to failures in the VSP detection algorithm for fire-like nuisances. Work in this area is ongoing. No other false positive events were generated by the VSPs to nuisance sources.

Overall, the VSPs demonstrated much better nuisance rejection capabilities than the commercial systems, except for the photoelectric detectors, which achieved a correct classification rate of 92% for nuisance sources (an 8% false positive rate). The better photoelectric performance was obtained, however, at a significant cost in terms of identifying flaming sources, discussed above, and in terms of response times, shown in the next section. The ionization detectors and both VID systems demonstrated a high sensitivity to nuisance sources, with VIDF correctly classifying only 51% of them. VIDA only 63%, and the ionization detectors only 65%. The nuisance sources to which the commercial systems generated false positives were toasting, welding, torch cutting, and grinding, all fire-like sources that produce real flames and smoke, though not of the sort that necessarily requires the attention of damage control personnel. The VID systems were originally designed to perform in much larger spaces, such as warehouses and tunnels, where fire-like nuisances similar to those employed in the VS5 test series seldom occur. To their credit, the VID systems have demonstrated excellent performance and commercial viability in their designed environments.

The best performance in combined results for fire and nuisance sources was obtained by the VSP detection systems with correct classification rates of 87% for VSP1 and 90% for VSP2, corresponding to false negative rates of 13% and 10%, respectively. Compared to the commercial systems, only the photoelectric detectors (86%) were near to the VSPs in performance.

The VSPs also demonstrated detection capabilities beyond those of the commercial systems. For water sources, comprising pipe ruptures, flooding, and suppression sources, the VSPs correctly classified 14 out of 16 sources (88%), corresponding to a false negative rate of 12%. The smoke detection algorithms of the VIDF system identified 4 water sources, one of which was not picked up by the VSPs, but counted as one extra correct classification for VSP1 (94%) in Table 3. The VIDA system did not detect any of the water sources in VS5, even though the smoke algorithms of the VIDA system also demonstrated this capability in an earlier test series [41]. The VSPs failed to identify one pipe rupture and one suppression source. For false positives, the VSP detection algorithms for water events incorrectly identified one gas release as a water event, and two torch cutting nuisances as suppression system activations due to the hissing sound generated by the torch itself. Overall, the performance of the VSPs with respect to water sources was very good.

For gas release sources, the VSPs correctly classified 9 out of 17 sources (53%), corresponding to a false negative rate of 47%. The VSPs failed to identify a variety of gas release sources, though no specific culprit was identified. For false positives, the VSP detection algorithm for gas release events incorrectly identified one suppression source as a gas release event. The VSPs did not generate any false positive gas releases events to nuisance sources. Though the algorithm detection rate was less than desired, the threat level information obtained for gas releases was highly accurate.

The time to alarm, or response time, of a detection system to a particular source was measured as the difference in seconds between the system's alarm time and the source's initiation time. The inherent variability of damage control and nuisance sources, even in a closed testing environment, resulted in large variances in response times for a given source class. Overall, observed response times varied from less than 30 seconds for some rapidly igniting flaming fires, to more than 30 minutes for some slowly developing smoldering fires. To compare the response times of different detection systems to sources in a selected class required an approach that was independent of this variation. This was accomplished on a per source basis by grouping the response times of the detection systems with respect to the first alarm to that source. Three groupings were used: within 5 seconds of the first alarm, within 30 seconds of the first alarm, and within 120 seconds of the first alarm. A grouping of 5 seconds was chosen for the first alarm as it encompassed the maximum uncertainty in time synchronization among the sensor systems. Results for all sources within a selected class (e.g., flaming sources) were compiled. Given n sources in a selected class, the percentage of response times in each group was calculated as the ratio of the number of response times to n for each detection system.

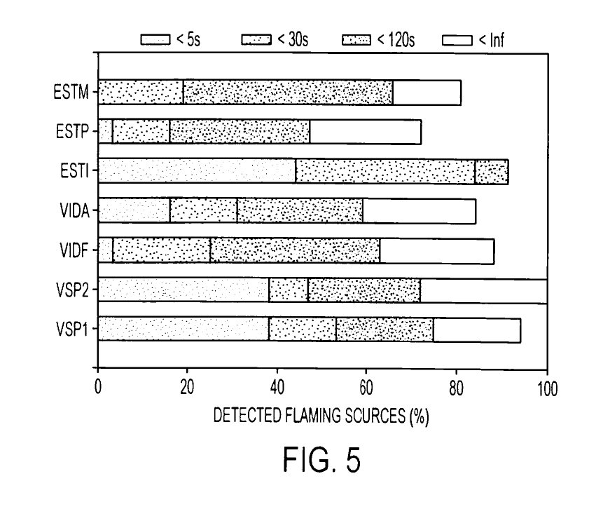

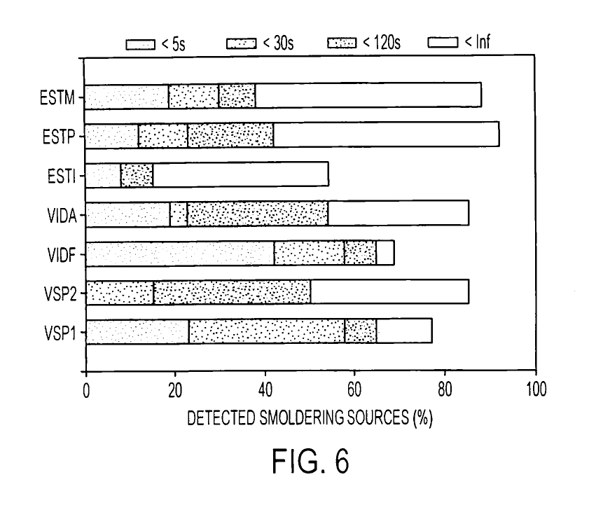

FIGS. 5 and 6 present the results of the time to alarm analysis for flaming and smoldering sources. Only sources for which all seven detection systems were simultaneously operating were selected for inclusion in the analysis. This restriction limited the number of flaming sources to 32 and the number of smoldering sources to 26 from totals of 38 and 28, respectively. The entries in the table represent the percentage of flaming or smoldering tests for which the detection system had alarmed within the time interval from first alarm indicated by the entry row. The percent correct classifications for flaming and smoldering sources listed in Table 3 can be taken as the infinite time limit for the time to alarm percentages due to the quasi-steady state criterion established for source termination. FIG. 5 includes the maximum percentage of the 32 flaming sources detected by each system prior to the cessation of data acquisition, and is shown as the interval “Inf,” and similarly for smoldering sources in FIG. 6.

The best performance for flaming sources was obtained by the ionization detectors, followed closely by the VSPs. Within 5 seconds of the first alarm observed for any flaming source, the ionization detectors had generated a fire alarm for 44% of the 33 flaming sources, the VSP systems generated alarms for 38% of the sources. Within 120 seconds, the ionization had alarmed to 91% of the flaming sources while the VSPs had alarmed to more than 70% of the sources. Note that the VSPs systems were markedly faster than the VID systems in responding to flaming sources. Further, compared to their percent correct classifications, the performance of the photoelectric detectors was the poorest of all the detection systems when evaluated with respect to time to alarm, where only 3% of fire sources were detected within the first 5 seconds, and 47% within 120 seconds.

The best performance for smoldering sources was obtained by the VIDF system, followed closely by VSP1 and the VIDA system. Within 5 seconds of the first alarm observed for any smoldering source, the VIDF system had generated a fire alarm for 42% of the 26 sources, VSP1 23%, and VIDA 19%. After 120 seconds, the VIDF system and VSP1 had generated alarms for 65% of the sources, VIDA 54%, and VSP2 50%. The time to alarm performance of the EST systems was overall much worse, though the photoelectric detectors were able to detect 42% of the smoldering sources within 120 seconds.

Finally, for water sources, the VSPs detected 50% of the sources within 60 seconds of initiation, and 88%, equal to all water sources detected by the VSPs, within 240 seconds. For gas releases sources, the VSPs detected 24% of the sources within 30 seconds of initiation, and 53%, equal to all gas release sources detected by the VSPs, within 60 seconds. Overall, the time to alarm performance of the VSPs with respect to water and gas release sources was excellent.

During the test, the VSP systems demonstrated the ability 1) to successfully monitor multiple compartments of varying size, shape, and content, 2) to detect and discriminate multiple simultaneous and consecutive damage control and nuisance events, and 3) to convey timely situational awareness to a supervisory control system.

The VSP systems were the most effective for detecting flaming fires and rejecting nuisances, and performed well at detecting smoldering fires. The VSP systems were much faster than the VID systems at detecting flaming fires, due to the rapid response of the long wavelength VID and spectral sensing components and their ability to perceive fire radiation reflected from walls and obstructions. The VSPs were initially slower than the VID systems at detecting smoldering fires, but comparable after 30 seconds from first alarm.

The VID systems performed very well at detecting fire sources, but markedly underperformed at nuisance rejection. The VIDF system was faster than VIDA at detecting smoldering sources, but VIDA was generally faster than VIDF at detecting flaming fires. The smoke detection algorithm of the VIDF system identified four water sources as smoke events, demonstrating proof-of-concept capabilities for VID-based detection of some types of flooding sources.

The photoelectric detectors were the most effective detecting smoldering fires and rejecting nuisances, but the least effective system for detecting flaming fires. The ionization and multicriteria detectors were better than the photoelectric at flaming fires, but not as effective as the VSP or VID systems. The ionization system was clearly the fastest system for the detection of flaming fires, however, it was also the slowest at detecting smoldering fires. The photoelectric and multicriteria were generally slower than the VSP and VID systems.

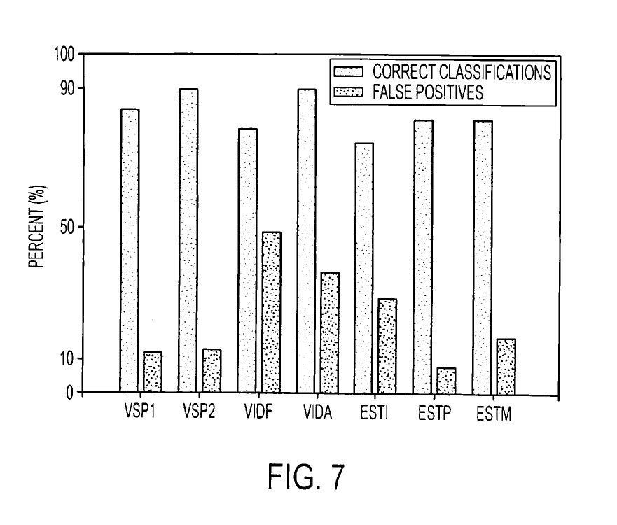

In terms of correct classifications of fire and nuisance sources combined, the VSP systems were the most effective detection systems overall, followed by the photoelectric detectors and the VIDA system, respectively. In terms of correct classifications of fire sources versus false positives due to nuisance sources, shown in FIG. 7, the VSP systems achieved the excellent rates of classification with low rates of false positives. Factoring in times to alarm, the VSP systems proved to be the most effective detection systems overall with VSP1 performing slightly faster than VSP2, and VSP2 performing slightly better than VSP1. The VSPs also provided effective situational awareness of pipe ruptures, flooding scenarios, fire suppression system activations, and gas release events not possible with the commercial systems. The VSPs achieved better overall performance than the commercial systems by using smart data fusion to combine the higher detection rates and faster response times of camera-based sensors (visible and long-wavelength) with the nuisance rejection capabilities of the spectral and acoustic sensors.

The results presented above were obtained without the benefit of the Bayesian-based event classifier. For demonstration purposes, a proof-of-concept implementation of the classifier was added to the DFM software via additional data fusion objects during the last day of testing in VS5. The extra algorithmic processing performed by the classifier had no discernible effect on fusion machine operation. The data acquired by VSP1 during VS5 was subsequently used to evaluate the performance of the data fusion decision algorithms with and without the classifier in real-time simulations with the entire dataset. The results obtained with the classifier showed an increase in correct classifications of fire sources and gas releases of 5% and 10%, respectively, over the results obtained without the classifier, with slightly faster times to alarm and no corresponding increase in false positives. These performance gains demonstrate the benefits for fire detection and situational awareness that can be attained with multivariate pattern recognition, even in the presence of noisy data.

Obviously, many modifications and variations of the present invention are possible in light of the above teachings. It is therefore to be understood that, within the scope of the appended claims, the invention may be practiced otherwise than as specifically described.

What is claimed as new and desired to be protected by Letters Patent of the United States is:

1. A method for detecting an event while discriminating against false alarms in a monitored space comprising the steps of:
providing at least one sensor suite in said monitored space,
acquiring at least one signal from said sensor suite;
transmitting said signal to at least one sensor system device;
processing said signal into data packets;
transmitting said data packets to a data fusion device;
aggregating said data packets and performing algorithmic data fusion analysis to generate threat level information;
distributing said threat level information to a supervisory control system; and
generating an alarm level when predetermined criteria are met to indicate the occurrence of an event in the monitored space.

2. A method as in claim 1, wherein the monitored space is in a ship.

3. A method as in claim 1, wherein said data packets comprise sensor data and sensor algorithm information.

4. A method as in claim 1, wherein said sensor suite comprising at least one optical sensor, at least one microphone, at least one near-infra-red camera and at least one visible spectrum camera.

5. A method as in claim 1, further comprising a plurality of sensor suites positioned in a plurality of locations.

6. A method as in claim 1, wherein said detected event is a flaming fire, a smoldering fire, a pipe rupture, a flooding event, or a gas release event.
